(19) United States
(12) Patent Application Publication
(10) Pub. No.: US 2015/0095933 A1
(43) Pub. Date: Apr. 2, 2015

(54) Device Pairing

(71) Applicant: Microsoft Corporation, Redmond, WA (US)

(72) Inventors: Helen Blackburn, London (GB); Christopher James Foulds, Chatteris (GB); Theo Colin Short, London (GB)

(73) Assignee: Microsoft Corporation, Redmond, WA (US)

(21) Appl. No.: 14/192,709

(22) Filed: Feb. 27, 2014

(30) Foreign Application Priority Data
Sep. 30, 2013 (GB) 1317294.5

(51) Int. Cl. H04N 21/426; H04N 21/61; H04N 21/462; H04N 21/258; H04N 21/478; H04N 21/422; H04N 21/643; H04M 7/00; H04N 21/485

(52) U.S. Cl. CPC H04N 21/42684; H04M 7/0078; H04N 21/6125; H04N 21/6175; H04N 21/4622; H04N 21/485; H04N 21/478; H04N 21/42203; H04N 21/64322; H04N 21/25875
USPC 725/25; 725/37

(57) ABSTRACT

Disclosed herein a user device. The user device comprises a network interface for connecting to an internet. The user device comprises a processor configured to execute a client application having a user interface. The client application is configured to detect a media device which is capable of communicating with the user device via a local connection; said local connection is not over the internet. The client is configured to cause the detected media device to display a pairing code—the causation being effected via said local connection—and to present, via the user interface, an option to input the displayed code. The client is configured to transmit the inputted code to the internet to establish a pairing relationship with the media device. The established pairing relationship enables interaction between the user device and the media device. A corresponding method, computer program product and media device are also disclosed.

### RELATED APPLICATIONS

This application claims priority under 35 USC 119 or 365 to Great Britain Application No. 1317294.5 filed Sep. 30, 2013, the disclosure of which is incorporate in its entirety

### BACKGROUND

Conventional communication systems allow the user of a device, such as a personal computer or mobile device, to conduct voice or video calls over a packet-based computer network such as the Internet. Such communication systems include voice or video over internet protocol (VoIP) systems. These systems are beneficial to the user as they are often of significantly lower cost than conventional fixed line or mobile cellular networks. This may particularly be the case for long-distance communication. To use a VoIP system, the user installs and executes client software on their device. The client software sets up the VoIP connections as well as providing other functions such as registration and user authentication. In addition to voice communication, the client may also set up connections for other communication media such as instant messaging (“IM”), SMS messaging, file transfer and voicemail.

Recently, internet capabilities and functionality has been integrated into a television set (often referred to as a “Smart TV”), or into a set-top box arranged to be connected to a television set. This includes the integration of client software into a television set to enable communications over a packet-based computer network such as the Internet. The embedding of a packet-based communication client in a TV allows a large screen to be utilised for video calling. Furthermore, significant processing power can be provided in the TV, particularly as the power requirements for a large, mains electricity powered consumer electronics device are less stringent than, for example mobile devices. This can enable a full range of features to be included in the embedded communication client, such as high quality voice and video encoding.

Smart TVs are also increasingly offering VoIP and other applications that require user-authenticated access to an Internet backend in order to provide access to a user's account, or to provide cross-platform features. Authenticating (logging in) a user may involve entering user credentials (e.g. username and password) at the TV using a standard TV remote control and an on-screen graphical User Interface (UI) keyboard.

Some Smart TV services—such as video on-demand streaming services—have implemented ‘remote authentication’ solutions allowing a user to log in to a TV application using an instance of the same application running at a user device. These solutions involve the user navigating menus on the TV using the TV remote control until they get to a screen displaying a unique pairing code within the application. The user then enters the displayed code at the user device to create a pairing relationship via the Internet. The code acts as a single shared secret during the remote authentication process and is transmitted over the internet for authentication.

### SUMMARY

The subject matter pertains to a user device. The user device comprises a network interface for connecting to an internet. The user device also comprises a processor configured to execute a client application having a user interface. The client application is configured to detect a media device which is capable of communicating with the user device via a local connection; said local connection is not over the internet. The client is further configured to cause the detected media device to display a pairing code—the causation being effected via said local connection—and to present, via the user interface, an option to input the displayed code. The client is further configured to transmit the inputted code to the internet to establish a pairing relationship with the media device. The established pairing relationship enables interaction between the user device and the media device.

The subject matter also pertains to a corresponding method, computer program product and media device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

For a better understanding of the present subject matter and to show how the same may be put into effect, reference will now be made, by way of example, to the following drawings in which:

FIG. 1 shows a schematic illustration of a communication system;

FIG. 2 shows a schematic illustration of a media device;

FIG. 3 shows a schematic illustration of a user device;

FIGS. 4A and 4B show a schematic representation of a method;

FIG. 5 shows a user device and a media device in one configuration;

FIG. 6 shows a user device and a media device in another configuration.

### DETAILED DESCRIPTION

Using existing techniques for establishing remote pairing relationships over the Internet a user has to manually navigate a graphical User Interface (UI) of a media device—e.g. television (TV)—using the TV's own dedicated remote control until they get to a screen where the unique pairing code is generated and displayed. The user also has to manually navigate a user interface at the user device until they get to a screen at which they can input the displayed code. The whole pairing process therefore requires the user to navigate user interfaces on both the TV and the user device in order to complete the remote pairing process and authenticate the user on the TV. This mechanism is used, for example, in video on-demand streaming services where a user can log in to the service at the TV using their user device and then use their user device to select videos to be played on the TV once logged on, with the user device controlling the TV via the Internet (i.e. signalling is via the internet)

Additionally, some TV manufacturers provide dedicated virtual remote control applications for user devices (e.g. smartphones) which allow the user device to be used as a ‘virtual’ remote control for controlling the TV over a local network (e.g. home WiFi network). The remote control app is intended as a substitute for the physical remote control supplied with the TV itself. These remote control apps can make use of discovery protocols—implemented over the local network—to allow user devices connected to the same local network to detect the TV and, once detected, to control the TV itself with the remote control app e.g. navigate menus of the TV; change channels; control volume, brightness etc. Signalling may be via the local network (not the Internet), or via the Internet (this may depend on the type of device(s)).

According to embodiments disclosed herein, use of a ‘discovery’ mechanism is integrated with use of a remote ‘pairing’ solution into the same application. This means a (remote) “pairing relationship” can be created with reduced user interaction and with reduced burden on the user and, in some embodiments, without the user having to use the TV remote control at all and without having to navigate any menus displayed at the TV.

As used herein, a “pairing relationship with a media device” is a relationship exploitable (e.g. over a public network, such as the Internet, to which both are connected) by a user device to interact with and control the media device (e.g. by the user device transmitting request data to the public network). The pairing relationship may, for instance, be between a user of the user device and the media device (so any user device at which the user is authenticated can exploit the pairing relationship); between the user device itself and the media device (so that user device alone can exploit the established pairing relationship); or between the user specifically as logged in at a particular device and the media device (so the pairing relationship can only be exploited when that specific user is logged on at that particular device). That is, user account/media device pairing, user device/media device pairing and user account+user device/media device pairing are all envisaged.

The pairing relationship is created by associating one or more identifying attributes of the user and/or user device with one or more identifying attributes of the media device during a secure pairing procedure e.g. by storing the relevant attributes in association with one another, for instance at a computer system of a service provider, subject to successful media device authentication based on a shared secret (pairing code) ascertainable only to those in the vicinity of the media device and with some form of localized access thereto. The service provider system thus ‘knows’ from this established relationship that the devices have permission to communicate with one another—in particular that the user and/or user device has permission to control the media device remotely—and thus allows communication therebetween by way of the service provider system without requiring any additional media device authentication. Thus, the pairing relationship effectively creates a paring link by which the devices can autonomously (i.e. freely) communicate with one another over the public network.

The embodiments described below make use of a discovery protocol to signal the availability of a TV to a user device. If a user selects the discovered (detected) TV in the user device UI, the TV is automatically switched into a ‘pairing mode’ (where it requests and displays the pairing code automatically), and the user device is automatically switched to a pairing screen where the user permits a pairing between their account credentials and the TV by inputting the code displayed on the TV.

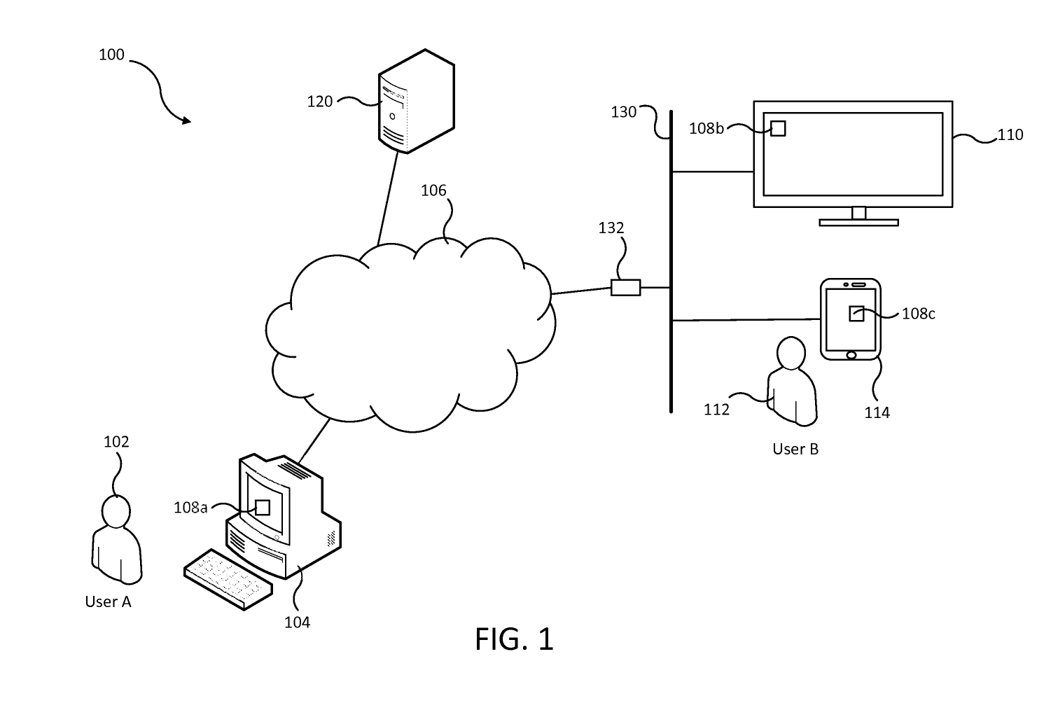

FIG. 1 shows a communication system 100 comprising a second user 102 who is associated with a second user device 104 and a first user 112 who associated with a first user device 114 and who is also in the vicinity of a media device 110, which is a television (“TV”) 110 in this embodiment.

It is common place for there to be one or more other devices in the same environment as a TV. For example, in a living room, user devices such as smart phones and laptop computers may also be present, and possibly connected to a common home (local) network.

FIG. 1 illustrates such an example of a user device, which in this embodiment is a tablet computer device 114. Whilst FIG. 1 shows a single user device 114 in addition to the TV 110, it will be appreciated that a plurality of devices may be present in the vicinity a media device, which in this embodiment is a TV 110.

The user device 114 and media device 110 are connected to a local network 130. Network 130 is Local Area Network (LAN). In embodiments, this may take the form of a wireless network (WLAN) operating based on a short-range radio access technology; e.g. in this embodiment the local network 130 is a home WiFi network (though other types of local network are envisaged). In this embodiment, devices 110 and 114 are connected to a router 132 of the local network 130. Router 132 is also connected to a wide area internetwork (internet) 106 such as the Internet, thereby connecting local network 130, and thus devices 110 and 114, to the internet 106. It will be appreciated that other devices, including other user devices, may be connected to local network 130.

User device 104 is also connected to the internet 106 (possibly via a further local network, not shown). Thus, the user device 104 can communicate over the internet 106 with the user device 114 or the TV 110, thereby allowing the users 102 and 112 to communicate with each other over the internet 106.

The communication system 100 shown in FIG. 1 is a packet-based communication system, but other types of communication system could be used. The internet 106 may, for example, be the Internet. Each of the user devices 104 and 114 may be, for example, a mobile phone, a tablet, a laptop, a personal computer (“PC”) (including, for example, Windows™, Mac OS™ and Linux™ PCs), a gaming device, a personal digital assistant (“PDA”) or other embedded device able to connect to the internet 106. The user devices 104 and user device 114 are arranged to receive information from and output information to the user of the respective device. The user devices 104 and user device 114 comprise output means such as a display and speakers. The user device 104 and user device 114 also comprise input means such as a keypad, a touch-screen, mouse, a microphone for receiving audio signals and/or a camera for capturing images of a video signal. The user devices 104 and the user device 114 are connected to the internet 106. For a touch-screen, the user may input commands by way of swipes or gestures. Router 132 forwards data packets between networks 106 and 130 (as will be appreciated, this functionality can be alternatively implemented by one or more network and/or computer devices).

The user device 114 and TV 110 are local to one another. That is, they can interact with one another without making use of internet 106 (i.e. they interact through transmission and/or reception of data which does not take place over internet 106). In this embodiment, devices 114 and 110 are local to one another by virtue of both devices 114 and 110 being connected to local network 130 (and, specifically, to router 132); that is, local interaction is effected by transmission and/or reception of data confined to local network 130 (specifically, via router 132).

As will be appreciated, devices 110 and 114 can also interact with one another remotely over internet 106 through transmission and/or reception of data over internet 106 (e.g. by exchanging data with one another via one or more network nodes such as server 120 or user device 104, or by one of said devices transmitting data to one or more network nodes thereby causing the network node(s) to transmit other, possibly different, data to another of said devices). Of course, for remote interaction, data will still ultimately be received from and/or initially transmitted over local network 130; nevertheless, this data still traverses internet 106 as well (in contrast to local data which do not).

The user device 104, user device 114, and the TV 110 each execute an instance of a communication client application 108, provided by a software provider associated with the communication system 100. The communication client is a software program executed on a local processor in the respective device. The client performs the processing required at the device in order for the device to transmit and receive data over the communication system 100.

Communication system 100 also comprises a back-end server 120 of a computer system associated with a service provider (e.g. an operator of internet 106). Both device 114 and TV 110 are operable to communicate with back-end server 120 over internet 106. Although shown as a single server, it will be appreciated that the functionality of server 120 may be divided between any number of suitable computing devices. The service provider may also be a cloud service provider, with the server 120 a “virtual server” (i.e. with the server functionality simulated by software running on one or more computer devices).

Each communication client instance 108a, 108b, 108c has a log in/registration facility which associates the user device 104, TV 110 and user device 114 with a particular respective user. Users can have communication client instances running on other devices associated with the same log in/registration details. Clients 108a, 108b and 108c are instances of the same client application 108. User 102 is authenticable (capable of being authenticated), using user credentials of user 102 (e.g. username, password) at client 108a; user 112 is authenticable at both device 114 and TV 110 using in user credentials of user 112. That is, clients 108a (resp. 108b and 108c) are operable to allow users 102 (resp. 112) to log in at client 108a (resp. 108b and 108c).

In the case where the same user, having a particular username, can be simultaneously logged in to multiple instances of the same client application on different devices, back-end server 120 is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system.

User 102 is logged-in (authenticated) at client 108a of device 104 as “User A”. User 112 is logged-in (authenticated) at client 108c of device 114 as “User B”; as discussed in detail below, in accordance with the present disclosure, user 112 is also able to log-in at TV 110 as “User B” through interaction with client 108c of user device 114 alone.

The TV 110 is connected to the internet 106 via a network interface such as a modem. The TV 110 shown in FIG. 1 is a standalone unit, but it should be appreciated that a separate TV and set-top box (STB) or other TV-connected device can also be used.

The TV 110 is executing a communication client instance 108b. Note that in alternative embodiments, the client can be executed in a STB. The client 108b comprises software executed on a local processor in the TV 110.

The TV 110 is arranged to receive information from and output information to the user 112. A remote control unit may act as an input device operated by the user 112 for the control of the TV 110. The TV 110 can also receive broadcast television signals broadcasting television programs, and display these as video (television programmes) to the user on the TV screen. The broadcast television signals can be delivered by terrestrial, satellite or cable broadcasting, and be in the form of analogue signals or digital data.

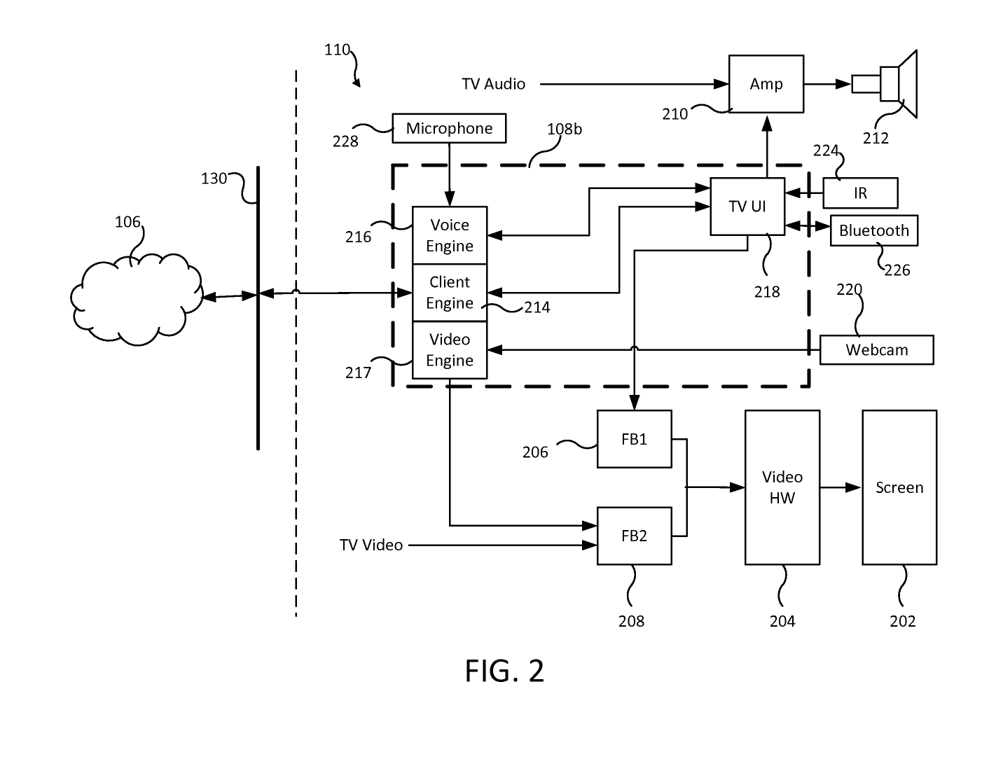

Reference is now made to FIG. 2, which illustrates the hardware and software functional blocks embedded in the TV 110. The TV 110 comprises a number of output components including a screen 202 and at least one speaker 212. The screen 202 is for displaying images to the user 112 and is driven by video driver hardware 204 arranged to convert video signals into the form required to be correctly displayed on the screen 202. The video driver hardware 204 is provided with digital video data from two frame buffers 206 and 208. The frame buffers 206 and 208 are storage devices that buffer video data that is to be displayed to the user. Frame buffer 2 (“FB2”) 208 receives standard TV video signals, as is known for the display of broadcast TV. Frame buffer 1 (“FB1”) 206 stores video data related to the packet-based communication client, as will be described presently. An audio amplifier 210 receives TV audio signals and amplifies these for output through at least one speaker 212.

The TV audio and video input signals themselves originate from television signals broadcast via any suitable means such as a satellite repeater stations, wireless terrestrial repeater stations or cable; and received by a television receiver unit of the TV 100 (not shown). Note that broadcasting is distinct from point-to-point communication, including being distinct from multicasting (i.e. point-to-multipoint). In broadcasting, signals are transmitted indiscriminately, i.e. regardless of whether the user has selected to receive the signal (although a decryption key or such like may still be required so that only authorised users can access the broadcast); whereas in point-to-point communication, signals must be requested by the user or users receiving them. Or put another way, to receive a broadcast a user simply “tunes in” without needing to send any signal to the broadcaster, whereas to establish a point-to-point connection then signals must be exchanged between the user and broadcaster. The TV may alternatively or additional receive on-demand television programs e.g. via the internet 106 or via, say, a fibre optic cable or satellite connection operated by a television service provider.

The TV receiver unit may comprise for example an antenna, satellite dish or cable input; sampling circuitry; a filter; a low noise amplifier; a mixer, and/or an analogue to digital converter. After being received by the receiver unit, the signals are then processed by a signal processing apparatus (also not shown) before being input to the frame buffers and amplifiers of FIG. 1. Such signal processing is well known to persons skilled in the art and is therefore not discussed in detail herein.

The packet-based communication client instance 108c in the TV 110 is based around four main elements. These four elements are shown as software elements that are stored in a memory and executed on a processor. The four elements are: a client engine 214; an audio engine 216; a video engine 217; and a TV user interface 218.

The client engine 214 is responsible for setting up connections to the packet-based communication system. This is performed via a connection from the TV 110 to the internet 106. The TV 110 is connected to the local network 130 (and thus to internet 106 via router 132) via a network interface 122 such as a modem, and the connection between the TV 110 and the network interface may be via a cable (wired) connection or a wireless connection. The client engine 214 performs call set-up, authentication, encryption and connection management, as well as other functions relating to the packet-based communication system such as firewall traversal, presence state updating, and contact list management.

The audio engine 216 is responsible for the encoding of voice signals input to the TV 100 via a microphone 228 as VoIP packets for transmission over the internet 106 and the decoding of VoIP packets received from the internet 106 for presentation as audio information to the user 112 of the TV 110. The microphone 228 may be integrated into the TV 110 or be connected to the TV 110 by way of a wired or wireless connection.

The video engine 217 is responsible for the encoding of video signals input to the TV (e.g. from a webcam 220 or other video camera) as video packets for transmission over the internet 106 in a video call, and the decoding of video packets received from the internet 106 in a video call for presentation as video images to the user 112 of the TV 110. The webcam 220 may be integrated into the TV 110 or be connected to the TV 110 by way of a wired or wireless connection.

The TV user interface (“UI”) 218 is responsible for presenting visual information to the user 112 of the TV 110 in the form of a graphical user interface displayed on the TV screen 202.

The client engine 214 is connected to the TV UI 218 in order to control what the UI displays to the user. The client engine 214 is also closely integrated with the audio engine 216 and video engine 217 for the efficient transmission and receiving of voice and video packets over the internet 106.

The video engine 217 is connected to FB2 208 for providing video data to be displayed on the TV screen 202.

The TV UI 218 is connected to FB1 206, so that the graphical user interface data is buffered and ultimately displayed to the user on the screen 202. The TV UI 218 is also connected to the amplifier 210, enabling sound (such as voice signals or notifications) to be produced from the TV speakers 212. The TV UI 218 may also be connected to an infra-red (“IR”) receiver 224 and/or a Bluetooth transceiver 126 which are used for communicating with a remote control unit.

Note that if the client 108b is provided in a STB (or other TV-connected device such as a games console) for connection to a TV, then the system in FIG. 1 may differ only in that the screen 202, amplifier 210, speaker 212, webcam 220 and microphone 228 blocks may be located in the TV itself, whereas the remaining functional blocks are located in the set top box, which is connected to the TV.

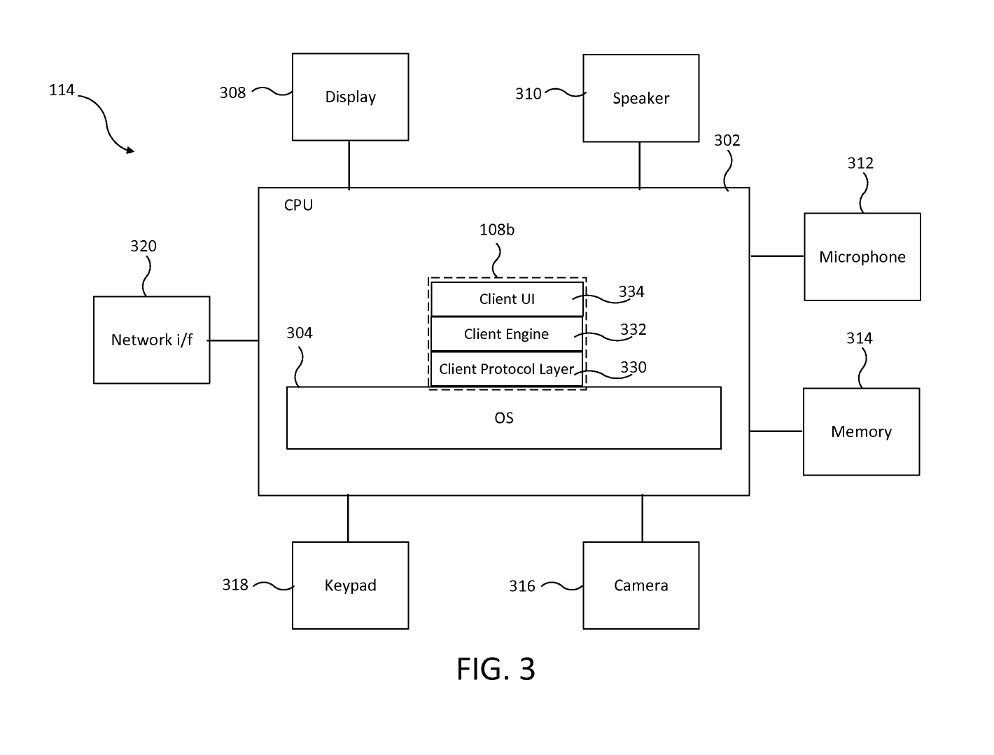

FIG. 3 illustrates a detailed view of the user device 114 on which is executed communication client instance 108c for communicating over the communication system 100. The user device 114 comprises a central processing unit (“CPU”) or “processing module” 302, to which is connected: output devices such as a display 308, which may be implemented as a touch-screen, and a speaker (or “loudspeaker”) 310 for outputting audio signals; input devices such as a microphone 312 for receiving audio signals, a camera 316 for receiving image data, and a keypad 318; a memory 314 for storing data; and a network interface 320 such as a modem for communication with the internet 106. The user device 114 may comprise other elements than those shown in FIG. 2. The display 308, speaker 310, microphone 312, memory 314, camera 316, keypad 318 and network interface 320 may be integrated into the user device 104 as shown in FIG. 2. In alternative user devices one or more of the display 308, speaker 310, microphone 312, memory 314, camera 316, keypad 318 and network interface 320 may not be integrated into the user device 114 and may be connected to the CPU 302 via respective interfaces. One example of such an interface is a USB interface. If the connection of the user device 114 to the internet 106 via the network interface 320 is a wireless connection then the network interface 320 may include an antenna for wirelessly transmitting signals to the internet 106 and wirelessly receiving signals from the internet 106.

FIG. 3 also illustrates an operating system (“OS”) 304 executed on the CPU 302. Running on top of the OS 304 is a software stack of the client instance 108b of the communication system 100. The client 108b communicates with the operating system 304 and manages the connections over the communication system. The client 108b has a client user interface which is used to present information to the user 112 and to receive information from the user 112. In this way, the client 108b performs the processing required to allow the user 102 to communicate over the communication system 100. The software stack shows a client protocol layer 330, a client engine layer 332 and a client user interface layer (“UI”) 334. Each layer is responsible for specific functions. Because each layer usually communicates with two other layers, they are regarded as being arranged in a stack as shown in FIG. 2. The operating system 304 manages the hardware resources of the computer and handles data being transmitted to and from the internet 106 via the network interface 320. The client protocol layer 300 of the client software communicates with the operating system 304 and manages the connections over the communication system. Processes requiring higher level processing are passed to the client engine layer 332. The client engine 332 also communicates with the client user interface layer 334. The client engine 332 may be arranged to control the client user interface layer 334 to present information to the user 112 via the user interface of the client and to receive information from the user 112 via the user interface.

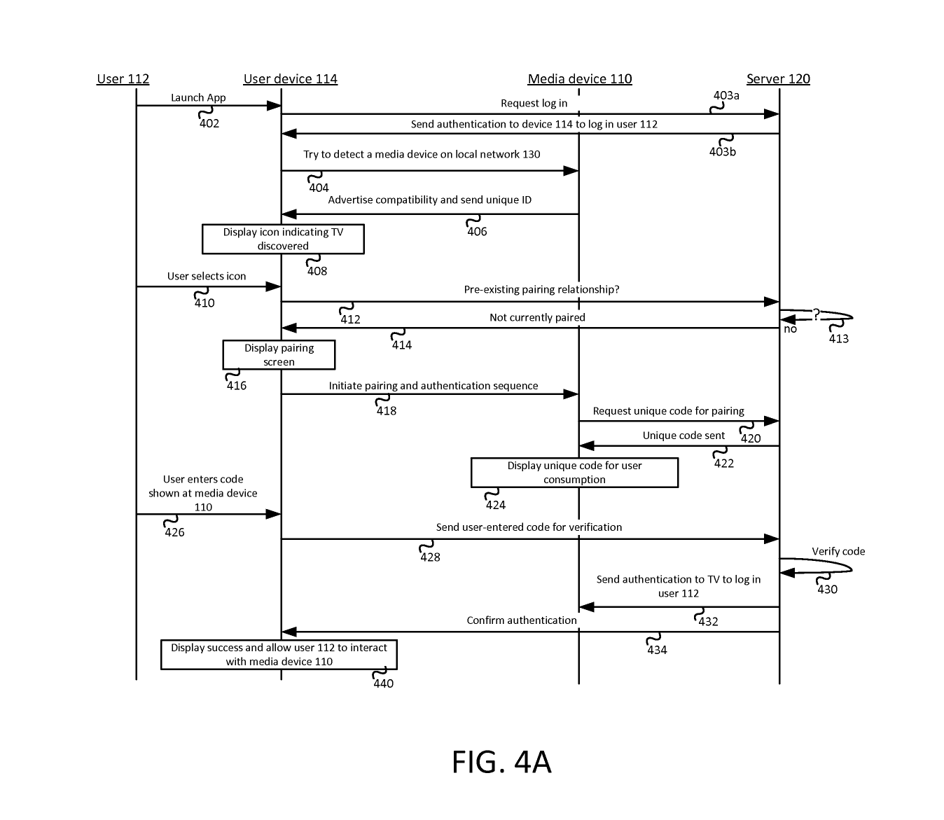

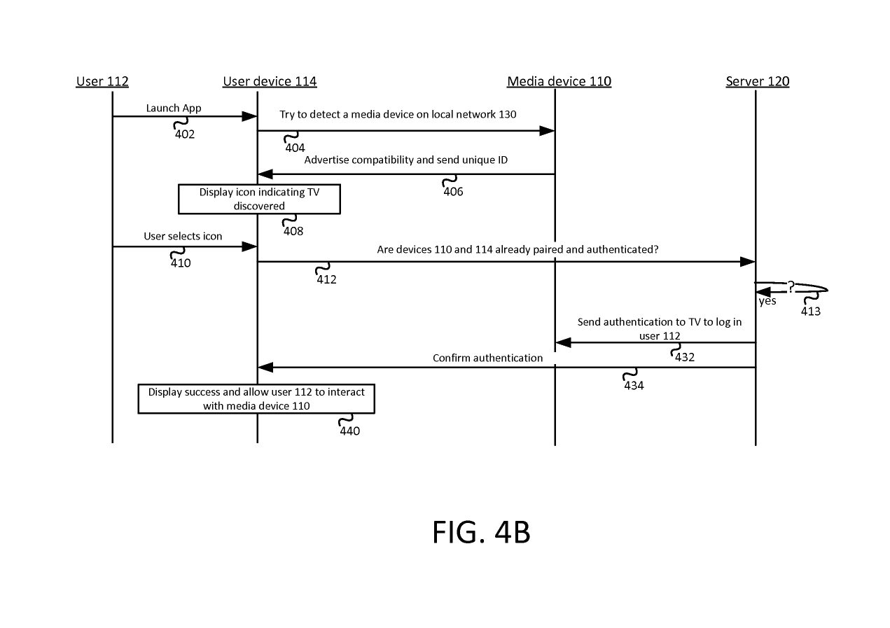

A method in will now be described with reference to FIGS. 4A and 4B. Among other things, the method involves determining (step 413) whether or not user 112 of device 114 and the media device 110 have a previously-established remote pairing relationship (e.g. whether a MAC address of the TV is already associated with a user account of the user). In this embodiment, the pairing relationship is established by storing, within internet 106, a network address of device 110 in association with a user account of user 112, “User B” being a user name of that account. User-specific information—such as contact lists and associated presence information, call credit, call history, chat history etc.—is stored in association with user 112's account at the computer system of the service provider of communication system 100, thereby allowing use 112 to access this information via a client executed at any suitable device provided they are logged in as “User B” (e.g. client 108c).

FIG. 4A illustrates a sequence of initial steps performed if the user 112 and media device 110 do not have an existing remote pairing relationship whilst FIG. 4B illustrates a sequence of steps performed if the user 112 and device 110 do have an existing remote pairing relationship.

The method comprises the client 180c of user device 114 detecting the media device 110 which, as discussed, is local to the user device 114. In order to effect this detection, both devices 110 and 114 participate in a local discovery (detection) procedure. In this embodiment, the local discovery procedure involves exchanging data over local network 130 (and not over internet 106). The media device is discoverable to (detectable by) the user device in the sense that the user device is able to determine that the media device is present and that the media device is capable of communicating with the user device via a local route not over internet 106 (in contrast to any remote connection which is over internet 106, via one or more nodes of internet 106). In embodiments, the local connection is via the local wireless network 130, e.g. WiFi network. That is, devices 110 and 114 are capable of a local communication which does not make use of internet 106 i.e. which does not require any exchange of data over internet 106 (in this embodiment, local exchange of data is restricted to local network 130).

Once the media device has been detected by client 108c, the client 108c of user device 114 instigates a remote media device authentication procedure by causing the detected media device to display a pairing code, thus making the pairing code ascertainable but only to those in the vicinity of the media device. This causation is effected via the local route (that is by the aforementioned local communication, without exchanging any data over internet 106). The pairing code is a code suitable for establishing the remote pairing relationship with the media device. The same client 108c is also operable to present, via the user interface of client 108c, an option for the user 112 to input the displayed code and, once user 112 has input the displayed code, to transmit the inputted code to the network (specifically to server 120) to establish said pairing relationship with the media device. Server 120 is then able to determine whether the code received from client 108c matches that displayed at media device 110. If so, server 120 creates a remote pairing relationship between user 112 and device 110 which is persistent in the sense that it is maintained pseudo-indefinitely (or at least until, say, user 112 or a user of the media device elects to terminate the pairing relationship). Server 120 can then automatically log user 112 on at media device 110 as “User B” not only in response to said determination but also at any point in the future at which a client executed on a user device and logged in as “User B”—which may or may not be user device 114—detects media device 110. That is, one the pairing relationship has been established, both device 114 and devices other than device 114 can exploit the existing pairing relationship without having to undergo another pairing procedure, provided user 112 is logged in as “User B” thereat.

The TV 110 is configured to allow the established pairing relationship to cause modified operation of the TV (e.g. comprising automatically logging in a user at the TV).

Method steps of FIGS. 4A and 4B are all either implemented automatically or in response to user 112 interacting with a single client application instance (i.e. single instance of an end-user program managed and scheduled as a single process by the OS during execution) 108c executed at their user device 114. Thus, user 112 is not at any stage required to interact with TV 110 directly (for instance using the TV remote control to navigate various onscreen menus at the TV), nor are they required to switch between different applications at user device 114.

The steps of FIG. 4A will now be described in detail. At step 402, user 112 launches (instigates execution of) client 108c by selecting an option presented by operating system 304. Client 108c then performs a user authentication procedure to log user 112 on at client 108c as “User B”. The user authentication procedure is performed based on user credentials (such as the username “User B” and a corresponding password associated with user 112's user account) which serve to identify and authenticate user 112 to the service provider of communication system 100. Depending on the configuration of client 108c, user 112 may be required to enter these credentials and elect to log in, or the user credentials may be stored at device 114 such that the client 108c is operable to log in automatically upon launch.

Alternatively, client 112 can log in automatically using an ‘authentication token’ which acts as a ‘key’ to allow login. This “authentication token” is created following a pervious successful log-in attempt: the first time user 112 enters their credentials, they are given a ‘token’ which is a key for signing in in the future without needing to enter their credentials again (e.g. username/password). This token negates the need to store the physical credentials locally.

The user authentication procedure involves transmitting (403a) the user credentials to server 120 which compares the transmitted user credentials to those stored thereat in association with user 112's user account and determining whether or not they match. If so, server 120 transmits (403b) an authentication message to user device 114 in order to log in user 112 at client 108c as “User B”, thereby granting user 112 access to the user-specific information of their user account. If not, user 112 is not logged in but may be permitted to make further (possibly finitely numbered) attempts to log in again.

Client 108c of user device 114 then attempts to detect (404) any other devices connected to local network 130 by (locally) broadcasting a request message throughout local network 130. In response to receipt thereof, client 108b of TV 110 transmits (406) a response message to user device 114 over local network 130. The response advertises compatibility of client 108b with client 108c and comprises a unique identifier of the media device which is a Media Access Control (MAC) address in this embodiment (alternatives will be apparent). Client 108c detects TV 110 by receiving this response message. Clients 108b and 108c thus participate in a local detection procedure which enables client 108c to detect TV 110. In this embodiment, the detection procedure is implemented using the Simple Service Discovery Protocol (SSDP). SSDP is known in the art and such implementations thereof will be readily apparent to a person skilled in the art. The detection procedure is a local detection which is not effected over the internet 106.

In response to receiving the response message, client 108c displays (408) a selectable icon (option) to indicate discovery of TV 110. As explained below, selection of this icon at device 114 triggers display of a pairing code at TV 110 without any further user input required between detection of TV 110 and displaying of the code. In response to user 112 selecting this icon (410), client 108c transmits (412) a query to server 120 to ascertain whether or not there is a pre-existing pairing relationship between user 112 and TV 110. The query comprises the unique identifier of TV 110 (MAC address). At step 413, server 120 determines whether or not the unique identifier is already stored in association with user 112's user account to determine whether or not there exists a pre-established pairing relationship between user 112 and TV 110. If so, the method proceeds in accordance with FIG. 4B (see below). If not, server 120 transmits (414) a message to device 114 indicating that there is no such pre-existing pairing relationship. In this case, even if there is some form pairing of the actual devices within the service provider system, this would transparent to the user.

Responsive to receipt of the message indicating that there is no such pre-existing pairing relationship, client 108c instigates a remote pairing procedure in order to establish, over internet 106, a remote pairing relationship with TV 110. Specifically, in response to receipt thereof, client 108c displays (416) a pairing screen to indicate to user 112 that the pairing procedure has been initiated and, also in response to receipt thereof, instigates a media device authentication sequence by transmitting a control message to TV 110 over local network 130.

Responsive to receipt of the control message, client 108b of TV 110 transmits (420), over internet 106, a request for a bespoke pairing code to server 120. Responsive to receipt thereof, server 120 transmits (422), over internet 106, the bespoke code to TV 110. This code may, for instance, be a numerical/alphabetical/alphanumerical code, (pseudo)randomly generated by server 120, which can be considered unique in the sense that the likelihood of guessing this code, or (pseudo)randomly generating the same code, is so low as to be effectively impossible. This may be achieved, for instance, by randomly generating a code of having a length of no less than, say, 4-6 characters. Responsive to receipt of this code, client 108b of TV 110 displays (424) the code for user-consumption. Display of the code is automatic in the sense than no user input is required at the TV 110.

Returning to FIG. 4A, the pairing screen displayed at step 416 is arranged so as to enable the user 112 to input the code displayed at TV 110. At step 426, user 112 inputs the code displayed at TV 110 to device 114.

For example, the pairing screen may comprise a touchscreen keyboard with which user 112 can manually enter the displayed code. The inputted code is received by client 108c. Alternatively or additionally, TV 110 may display the code in the form of a Quick Response (QR) code and the pairing screen may present an option to use the camera 316 of device 114 to capture an image of the QR code (e.g. by tapping or swiping a soft-button on a touch screen or by making a suitable gesture command) which is then received and decoded by client 108c of device 114.

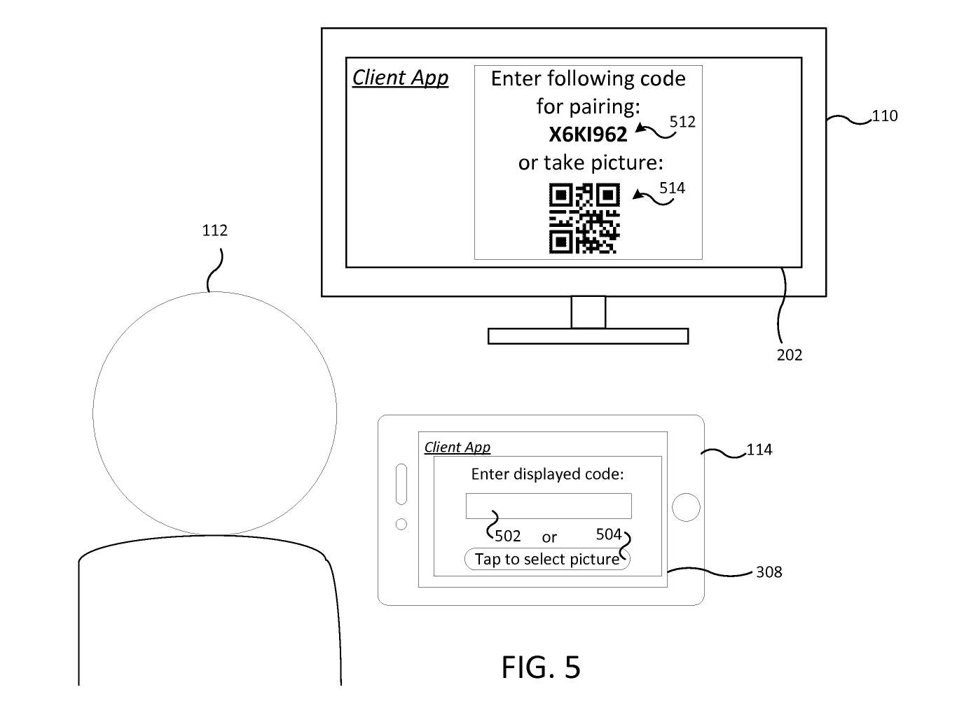

FIG. 5 is an exemplary illustration of the displays of device 114 and 110 after completion of steps 416 and 424. As shown in FIG. 5, in this embodiment, client 108b of TV 110 displays the code in the form of an alphanumerical identifier 512 for manual entry and in the form of a QR code 514. Client 108c of device 114 displays an option 502 to enter the code manually and an option 504 to take a picture of the QR code.

As will be apparent form the above and from FIG. 4A, in order to place TV 110 in a state in which the code is displayed at TV 110 and the user device 114 in a state in which the pairing screen is displayed at device 114, the user need only select (410) the icon indicating discovery of TV 110 as displayed by client 108c at user device 114; thereafter, the method (412-424) proceeds automatically up to display of the code at TV 110 with no further user input required up to that point. Moreover, the user is never required to interact directly with the TV 110 e.g. by manipulating the remote control or other device/application to navigate menus of the graphical user interface of TV 110—rather, the method is controlled entirely through the user interface of the single client application instance 108c at user device 114.

In other words, during a period running from detection of the media device to display of the code at the TV, no more than one user input is required at the user device and no user input is required at the media device to place both the device 114 and TV 110 into a pair-ready state in which the TV 110 displays the pairing code and the user device 114 displays a pairing screen for inputting the displayed code.

Moreover, this efficient, highly-automated process ensures that signalling to the media device is minimized, in contrast to (say) a situation in which a user is required to manually navigate TV menus using e.g. a TV remote control to bring up a code-screen (which is a cumbersome and imprecise process, prone to error and thus liable to involve unnecessary signalling to enter/exit unwanted menu screens).

Returning to FIG. 4A, responsive to receiving the inputted code, client 108c of device 114 transmits (428) the inputted code to internet 106 such that it is received by server 120. The code is transmitted in a manner that makes it apparent to the server 120 that said transmission has originated a logged in as “User B” (i.e. client 108c). Server 120 then verifies (430) the received code by comparing the received code to that transmitted to the TV 110 by the server 120 at step 422. If the codes do not match, the server 120 transmits (not shown) an error message to user device 114. If the codes match, server 120 stores the unique identifier of TV 110 (received at step 412) in association with the user account of user 112 (associated with username “User B”), thereby creating a remote pairing relationship between user 112 and TV 110. The code thus acts as a “shared secret” between clients 108b and 108c for the pairing procedure. Thereafter, whenever server 120 receives (412) a query transmitted by a client logged in as “User B” comprising that identifier, the method proceeds from step 413 as described with reference to FIG. 4B (see below).

Having verified the code, server 120 transmits (432), over internet 106, an authentication message to TV 110 in order to log in user 112 at client 108b as “User B” automatically (as the server 120 knows that the code received over internet 106 originated from a client already logged in as “User B”). Thus, the established pairing relationship causes modified operation of TV 110, which client 108b of TV 110 is operable to allow (client 108b is also operable to allow the established pairing relationship to cause additional modified operation at user 112's behest, examples of which are given below).

In this embodiment, the process of logging in to a Smart TV service or application—where the user is required to enter credentials (e.g. username/password) in order to sign in (log in)—is thus greatly simplified and can be achieved with minimal user input at the user device and with no user input at the TV, allowing the user to authenticate themselves (i.e. log in) at a TV without needing to enter credentials into the TV UI. In addition, by integrating the discovery mechanism into an application (client) on the user device on which the user has already been authenticated (i.e. logged in), the user is not required to re-enter their credentials on either device in order to sign-in the TV.

Server 120 also transmits (434), over internet 106, a confirmation message to user device 114 confirming successful authentication i.e. confirming that user 112 is logged in at TV 110 as “User B” and that TV 110 is thus authorized to access user 112's user-specific data of their user account. Responsive to receipt of this message, client 108c displays (440) an indication of successful pairing and successful login at the TV.

Thus, in a period running from detection of the TV to (successful) establishment of the pairing relationship, no more than two user inputs are required at the user device (one to initiate pairing; one to input the displayed code) and no user inputs are required at the TV in order to establish the pairing relationship.

Turning now to FIG. 4B, as illustrated, if at step 413 server 120 determines that the user device 114 and the TV 110 do have a pre-existing pairing relationship, the method proceed straight to step 432 and proceeds as above. The authentication message is re-issued to the TV behind the scenes—just in case the token on the TV has expired or been deleted in a period since it was last used. This pre-existing relationship may have been established previously between user device 114 and the TV, or between a different user device having the same user 112 (logged in as “User B”) and the TV 110, in a manner akin to than described above with reference to FIG. 4A. In other words, should the media device 110 become undetectable by the user device 114 (e.g. due to the user device or media device disconnecting from local network 130 or due to the user device moving out of range of the media device 110) client 108c is operable, upon subsequent redetection of the media device, to automatically exploit the established pairing relationship; that is, without the media device displaying, or needing to display, a pairing code at the TV in response to the redetection and without user 112 having to enter any displayed pairing code at device 114.

Following establishment of the remote pairing relationship—which enables clients 108c and 1086 to autonomously (i.e. freely in the sense than no further authentication is required) interact over internet 106—client 108c of user device 114 can exploit, at user 112's behest, the established remote pairing relationship, over internet 106, to modify operation of (i.e. control) TV 110 responsive to one or more user inputs received via the user interface of the client 108c. Following step 440 (in both FIGS. 4A and 4B), user 112 can select various options via the user interface of client 108c of user device 114 which, when selected, are implemented at the TV 110 over internet 106. That is which, when selected, cause the client to transmit one or more requests to server 120 over internet 106, the server 120 transmitting, over internet 106, one or more control messages to TV 110 in order to automatically implement these requests at TV 110.

For instance, user 112 may select at user device 114 one more of their contacts from their contact list and establish a communication event at TV 110 therewith (e.g. call conducted via TV 110) by selecting one or more options at user device 114 (and not at TV 110).

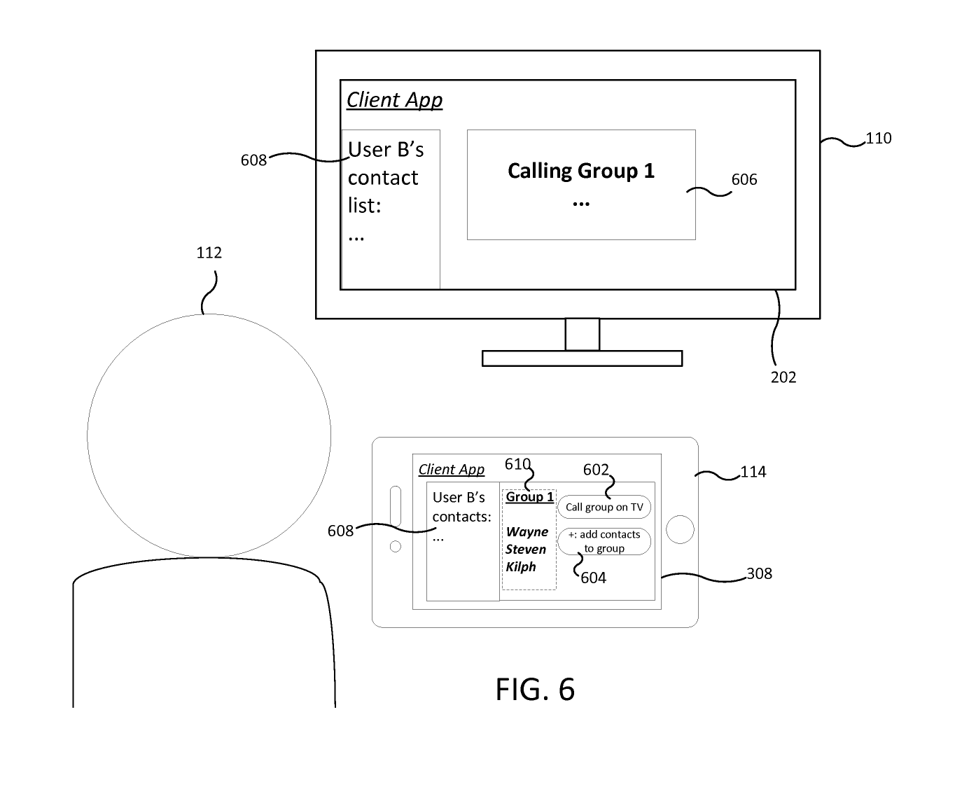

For example, in one embodiment illustrated in FIG. 6, client 108c presents user 112 with the option of 604 of adding of adding users from user 112's contact list 608 to a group 610. The contact list 608 is part of their user-specific account information and can be displayed at both user device 114 and TV 110 as shown (as both devices 110 and 114 are logged in as “User B” and thus have access thereto). Client 108c also presents user 112 of an option 602, selectable at the user device 114, of conducting a video call with members of this group using the TV 110. Responsive to selection of 602, device 114 transmits a group call request to server 120 over internet 106; in response to receiving this request, server 120 instructs TV 110 to initiate (606) a call to that group automatically (i.e. without user 112 having to interact with the TV).

Client 108c may also present to user 112 an option to transfer an incoming or pre-established communication event (e.g. voice or video call) to TV 110. Responsive to selection of this option, client 108c transmits a request to server 120 over internet 106 to so-transfer the call, which server 120 implements by transferring the communication event from the device 114 to the TV 110 over internet 106. The option may be to partially transfer the communication event e.g. if the communication event is a video call, the option may be to transfer only the video of the call to the TV 110 and to retain the audio at the device 114.

Client 108c may also present—e.g. in a conference room scenario—an option to initiate screen sharing between device 114 and TV 110, selection of which causes an image of a current screen layout of device 114 to be transmitted via server 120 to TV 110 for display thereat.

It will be appreciated that the embodiments are exemplary and alternatives will be apparent. For instance, in the above, a pairing relationship is established between a user and a media device by associating an identifier of the media device with a user account of the user such that that user can control the TV remotely using any device at which they are logged in provided they have gone through an initial pairing procedure using one such device. Alternatively or additionally, the pairing relationship may be established between a user device and a media device by associating an identifier of the user device with an identifier of the media device (and possibly with a user account of the user too), such that a user is required to go through an initial pairing procedure for every device they wish to pair with their TV before using that device to control the TV (and possibly such that the user also has to be logged in at each such paired device in order to control the TV remotely). The user device may transmit one or more identifying attributes of the media device (which may or may not include a MAC address), and possibly one or more identifying attributes of the user device and/or user accordingly, both to ascertain whether there exists a pre-established pairing relationship and to establish a pairing relationship if not.

Further, whilst in the above, the pairing relationship with a media device is persistent, in alternative embodiments the paring relationship may be temporary or session based e.g. expiring following a predetermined period from establishment, from cessation of detectability of the media device by a user device, or of inactivity between the user device and the media device etc. An option may be presented to a user of the user device and/or media device to establish a persistent or temporary pairing relationship, and/or to terminate either type of pairing relationship. Further, whilst in the above, a user device and a media device are local to one another by virtue of being connected to a same local network (over which the can exchange information), in alternative embodiments, devices may be local to one another by virtue of a direct, peer-to-peer connection which can be established there between (such as a Near Field Communication (NFC) connection, Bluetooth™ connection, or any other short range wireless technology, or any local connection not over internet 106).

Further, whilst in the above, the subject matter has been described in the context of a communication client application, in alternative embodiments the disclosed techniques may be implemented by any suitable client application including, but not limited to, social media applications, on-demand media applications media management applications etc. Further, whilst in the examples above media device 110 is a television, the subject matter is not limited to that type of media device and includes, but is not limited to, other types of media device (such as desktop computers, laptop computers, games consoles, tablet computers, smart phones etc.).

Further, whilst in the above the interaction as enabled by the established pairing relationship is over the internet, said interaction as enabled by the pairing relationship may alternatively or additionally be across the local connection.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user devices may also include an entity (e.g. software) that causes hardware of the user devices to perform operations, e.g., processors functional blocks, and so on. For example, the user devices may include a computer-readable medium that may be configured to maintain instructions that cause the user devices, and more particularly the operating system and associated hardware of the user devices to perform operations. Thus, the instructions function to configure the operating system and associated hardware to perform the operations and in this way result in transformation of the operating system and associated hardware to perform functions. The instructions may be provided by the computer-readable medium to the user devices through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A user device comprising:
a network interface for connecting to an internet;
a processor configured to execute a client application having a user interface, the client application being configured to:
detect a media device capable of communicating with the user device via a local connection, wherein said local connection is not over the internet;
cause the detected media device to display a pairing code, said causation being effected via said local connection;
present, via the user interface, an option to input the displayed code; and
transmit the inputted code to the internet to establish a pairing relationship with the media device, the established pairing relationship enabling interaction between the user device and the media device.

2. A user device according to claim 1, wherein the client application is configured to authenticate a user of the user device, and said pairing relationship is between the user and the media device.

3. A user device according to claim 2, wherein said transmission causes the media device to automatically authenticate the user at the media device.

4. A user device according to claim 1, wherein the client is configured to present, via the user interface, a selectable option in response to said detection, said causation being triggered responsive to selection thereof such that no further user input is required between said detection and said display.

5. A user device according to claim 1, wherein the user device is operable to connect to a local network, the local connection being via the local network, and said detection and said causation are effected over said local network.

6. A user device according to claim 5, wherein the network interface is operable to connect to the internet via said local network.

7. A user device according to claim 1, wherein said detection comprises locally broadcasting a request message, and receiving a response thereto from the media device, wherein said local broadcast is not over the internet.

8. A user device according to claim 1, wherein the client is operable to exploit the established pairing relationship, over the internet, to control operation of the media device responsive to one or more inputs received via the user interface of the client.

9. A user device according to claim 1, wherein the client is operable to exploit said pairing relationship to cause the media device to initiate a communication over the internet and/or to at least partially transfer an existing communication from the user device to the media device.

10. A user device according to claim 9, wherein the communication is one of a voice or video call.

11. A user device according to claim 9, wherein the communication is between a user of the user device and at least one other user selected by the user via the user interface of the client.

12. A user device according to claim 1, wherein the client is operable to exploit said pairing relationship to initiate screen-sharing between the user device and the media device.

13. A user device according to claim 1, wherein the client is operable to automatically exploit the established pairing relationship, over the internet, upon redetection of the media device.

14. A user device according to claim 13, wherein the client is operable to exploit the established pairing relationship to authenticate a user of the user device at the media device.

15. A user device according to claim 1, wherein the client is operable to transmit an identifier of the media device to the internet for storage therewithin to establish said pairing relationship.

16. A user device according to claim 1, wherein said interaction between the user device and the media device is over at least one of the internet and the local connection.

17. A media device configured to interact with the user device of claim 1, the media device comprising a display component and a processor, the processor configured to execute another client application, the other client application configured to implement said displaying step and, once said pairing relationship has been established, to interact with the user device over the internet.

18. At least one computer readable medium storing a client application which, when executed on a processor of a user device comprising a network interface for connecting to an internet, is configured to:
detect a media device capable of communicating with the user device via a local connection, wherein said local connection is not over the internet;
cause the detected media device to display a pairing code, said causation being effected via said local connection;
present, via the user interface, an option to input the displayed code; and
transmit the inputted code to the internet to establish a pairing relationship with the media device, the established pairing relationship enabling interaction between the user device and the media device.

19. A media device according to claim 17, wherein the client is configured to automatically authenticate a user of the user device at the media device in response to said interaction.

20. A method of establishing a pairing relationship, implemented by a client application executed at a user device, the method comprising:
connecting to an internet;
detecting a media device capable of communicating with the user device via a local connection, wherein said local connection is not over the internet;
presenting, via a user interface of the client, a selectable option in response to said detection;
causing the detected media device to display a pairing code, said causation being effected via said local connection and being triggered responsive to selection of said selectable option such that no further user input is required between said detection and said display;
presenting, via the user interface, an option to input the displayed code; and
transmitting the inputted code to the internet to establish a pairing relationship with the media device, the established pairing relationship enabling interaction between the user device and the media device;
wherein a user of the user device is authenticable at the client, and said pairing relationship is between the user and the media device; and
wherein said transmission causes the media device to automatically authenticate the user at the media device.
